(19) United States
(12) Patent Application Publication
(10) Pub. No.: US 2013/0181429 A1
(43) Pub. Date: Jul. 18, 2013

(54) Driver Airbag with Improved Head and Neck Injury Prevention

(71) Applicants: Tzu-Chen Weng, Troy, MI (US); Kirk David Arthurs, Newport, MI (US); John Vincent Fazio, Dearborn, MI (US); Chunhui Lee, Troy, MI (US); Djamal Eddine Midoun, Ann Arbor, MI (US)

(72) Inventors: Tzu-Chen Weng, Troy, MI (US); Kirk David Arthurs, Newport, MI (US); John Vincent Fazio, Dearborn, MI (US); Chunhui Lee, Troy, MI (US); Djamal Eddine Midoun, Ann Arbor, MI (US)

(73) Assignee: Ford Global Technologies, LLC, Dearborn, MI (US)

(21) Appl. No.: 13/348,697

(22) Filed: Jan. 12, 2012

(51) Int. Cl. B60R 21/16

(52) U.S. Cl. 280/731

(57) ABSTRACT

An airbag assembly includes a steering wheel, an airbag housing mounted to a hub of the steering wheel, and an airbag stored in the housing. The airbag includes a rim-facing panel, a driver-facing panel, an upper tether extending between the housing and a first location on the driver-facing panel opposite from the hub, and a lower tether extending between the housing and a second location below the first location. The tethers shape the airbag to have a thicker head contact portion adjacent to the upper rim of the steering wheel and a thinner chest contact portion adjacent to the lower rim of the steering wheel. The shape provides more balanced occupant protection in a frontal crash event, because the thicker head contact portion reduces the driver's head acceleration and neck injury.

### TECHNICAL FIELD

The present invention relates generally to occupant protection systems for automotive vehicles and, more particularly, to a driver airbag assembly mounted in a steering wheel.

### BACKGROUND

Current occupant safety systems in motor vehicles usually include a driver airbag to protect the vehicle driver against head, neck, and upper thorax injuries during a frontal collision. Driver airbags most commonly deploy from an airbag housing positioned in or on a center or hub of the steering wheel. Driver airbags deploy from the steering wheel housing to an inflated condition to cushion and prevent the driver's head and thorax from striking the steering wheel, dashboard, and other portions of the vehicle interior.

Proper placement and shaping of the driver airbag is important to minimize injury during a collision. It is known to utilize various types of internal tethers to control the inflated shape and positioning of the airbag relative to the steering wheel and the driver. One important injury mode that may be experienced by a vehicle driver during a frontal collision is flexion and extension of the neck as the driver's head is thrown forward relative to the shoulders and thorax.

### SUMMARY

In a disclosed embodiment, an airbag assembly for a motor vehicle comprises a steering wheel, an airbag housing mounted to the steering wheel, and an airbag attached to the housing that deploys therefrom when inflated. When the airbag is deployed, a head contact portion is above a horizontal centerline of the steering wheel and a chest contact portion is below the horizontal centerline, the head contact portion having a thickness greater than a thickness of the chest contact portion. An upper tether extends between the housing and a first location on a driver-facing panel of the airbag adjacent a dividing line between the head contact portion and the chest contact portion. A lower tether extends between the housing and a second location on the driver-facing panel on the chest contact portion.

In a further disclosed embodiment, an airbag assembly for a motor vehicle comprises a steering wheel, an airbag housing mounted to a hub of the steering wheel, and an airbag stored in the housing when in a deflated condition. The airbag comprises a rim-facing panel, a driver-facing panel, an upper tether extending between the housing and a first location on the driver-facing panel opposite from the hub, and a lower tether extending between the housing and a second location on the driver-facing panel below the first location. The tethers are located to shape the airbag in an inflated condition to have a head contact portion adjacent to the upper rim and a chest contact portion adjacent to the lower rim, the head contact portion being of a first thickness greater than a second thickness of the chest contact portion.

In a further disclosed embodiment, the airbag further comprises a wedge-shaped panel between and connecting the driver-facing panel and the rim-facing panel, the wedge-shaped panel being wider adjacent to an uppermost extent of the airbag

In a further disclosed embodiment, the head contact portion has a surface approximately parallel with a plane of the steering wheel

### BRIEF DESCRIPTION OF THE DRAWINGS

Embodiments of the present invention will now be described by way of example only with reference to the accompanying drawings in which:

FIG. 1 is a partial general arrangement view of a vehicle interior showing a steering wheel mounted airbag housing;

FIG. 2 is a side view of a driver airbag deployed from a steering wheel;

FIG. 3 is a front view of the airbag of FIG. 2;

FIG. 4 is a perspective view of the airbag of FIG. 2;

FIG. 5 is a schematic side view of an embodiment of the invention airbag assembly early in a frontal crash sequence;

FIG. 6 is a schematic side view of a prior art airbag assembly early in a frontal crash sequence;

FIG. 7 shows the airbag assembly of FIG. 5 at a time later in the crash sequence with the driver fully engaged with the airbag; and

FIG. 8 shows the airbag assembly of FIG. 6 at a time later in the crash sequence with the driver fully engaged with the airbag.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

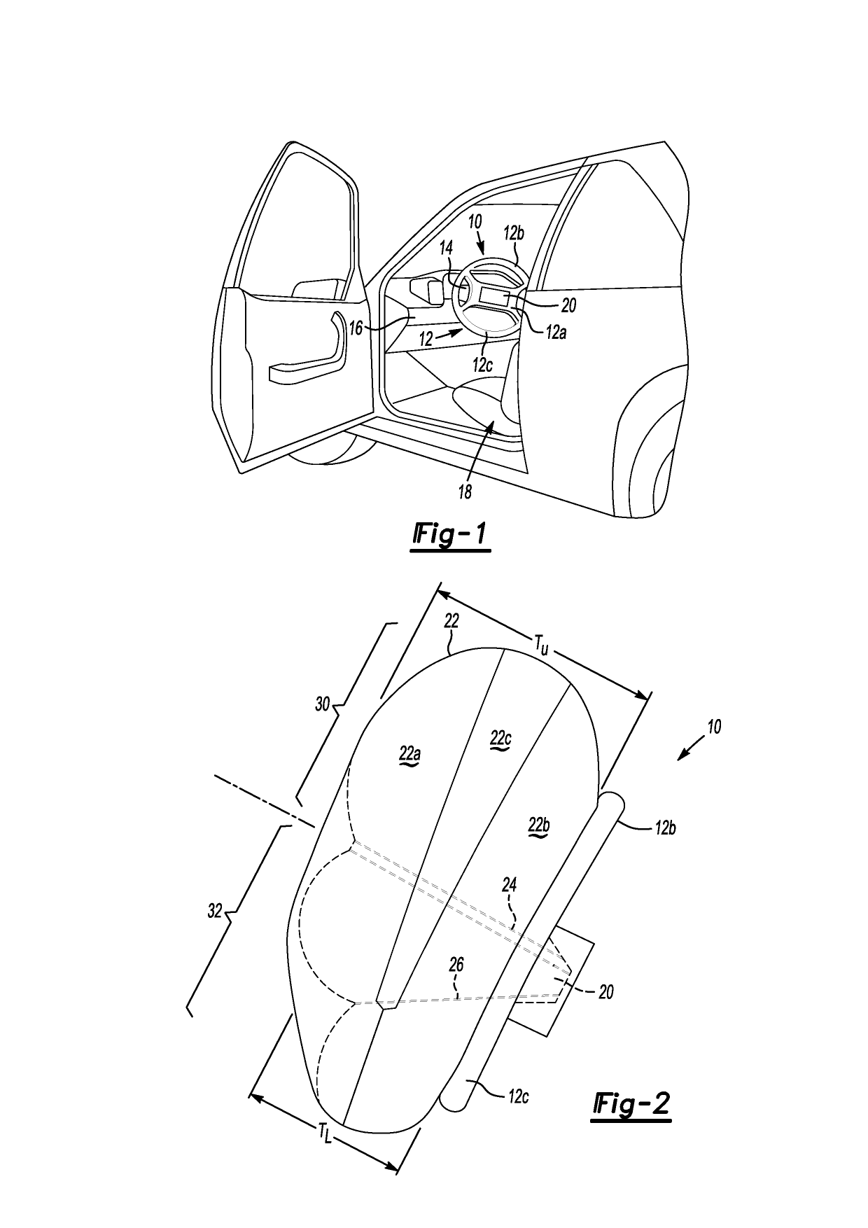

FIG. 1 shows an automotive vehicle interior to include a driver airbag assembly 10 comprising a steering wheel 12 mounted for rotation to a column 14 projecting from an instrument panel 16. A driver seat 18 is located in the conventionally known position as shown.

Steering wheel 12 has a central portion or hub 12a located at a horizontal centerline of the wheel, an upper rim 12b, and a lower rim 12c. Upper and lower rim portions 12b, 12c may be attached to hub 12a by any number and/or configuration of spokes, as is well known in the art. A driver airbag housing 20 is located in or on the steering wheel hub 12a and contains an airbag (not visible in FIG. 1) in a stowed or deflated condition, as it is prior to airbag activation by a crash sensing system, the general operation of which is well known.

FIGS. 2-4 show an airbag 22 in a fully deployed or inflated condition. In the depicted embodiment, airbag 22 comprises three separate panels: a driver-facing panel 22a, a rim-facing panel 22b, and a wedge-shaped central panel 22c. The three panels 22a, 22b, 22c may be made of a woven or non-woven fabric material and are joined together at seams, which may be stitched, glued, welded, etc, as is appropriate for the material of which the panels are made. This three panel construction is only for ease and economy of manufacture, and is not to be interpreted as a limitation on the invention.

An upper portion of airbag 22 is located adjacent to upper steering wheel rim 12b to provide a head contact portion 30, and a lower portion of the airbag is adjacent to lower rim 12c to provide a chest contact portion 32. Head contact portion 30 has a thickness T_{U} (measured generally perpendicular to the plane of steering wheel 12) greater than the thickness T_{L} of the chest contact portion 32.

The desired differential between the upper airbag thickness T_{U} and lower airbag thickness T_{L} is achieved by proper sizing/shaping of the airbag envelope (which may be made up or one or more panels) and by internal tethers 24, 25 as shown. Upper tether 24 is attached to airbag housing 20 and extends therefrom generally perpendicular to the plane of steering wheel 12. The other end of upper tether 24 is attached to driver-facing panel 22a at a location approximately at the dividing line between head contact portion 30 and chest contact portion 32. Upper tether 24 is preferably approximately 10 to 12 inches long. Lower tether 26 is attached to airbag housing 20 and extends at a downward angle as it extends away from airbag housing 20, being attached to driver-facing panel 22a at a location on the chest contact portion 32. Lower tether 25 is preferably approximately 6 to 8 inches long.

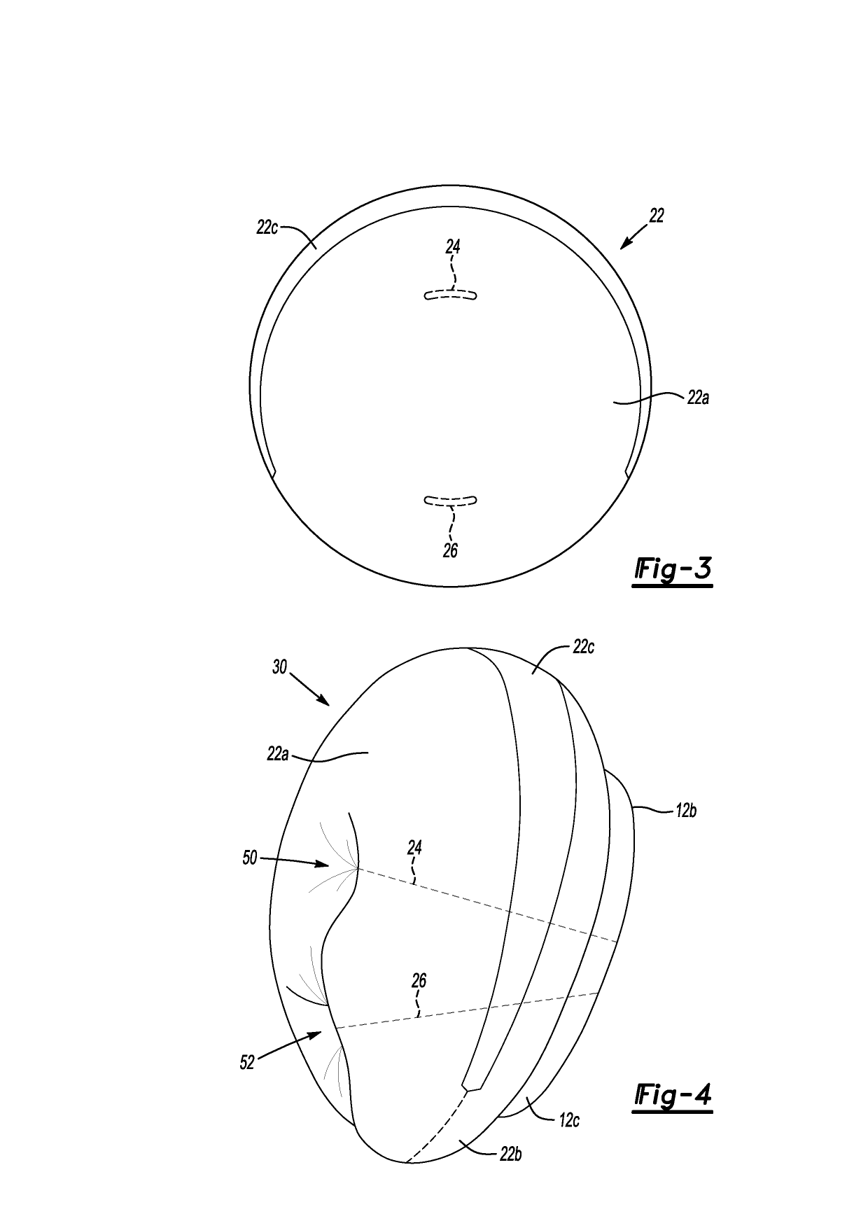

In the embodiment of the invention depicted, both tethers 24, 25 are straps in the approximate range of 2 to 4 inches wide and are secured to driver-facing panel 22a at the lateral center of the airbag (as best seen in FIG. 3), to achieve a laterally symmetric deployed condition. FIG. 4 shows an upper tether depression 50 formed in the location where upper tether 24 is attached to the airbag front panel 22a. Similarly, a lower depression 52 is formed at the location where lower tether 26 is attached to the driver-facing panel 22a.

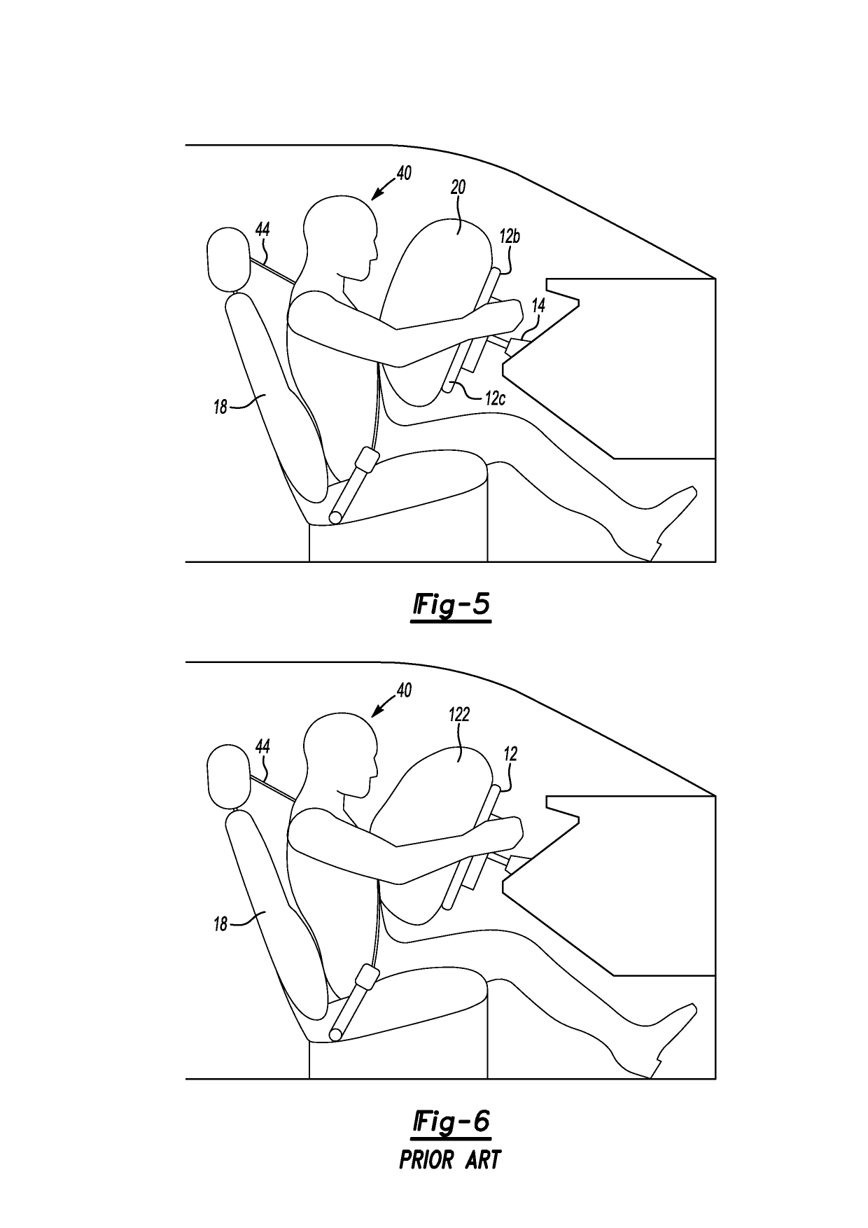

FIG. 5 shows an airbag 22 according to an embodiment of the present invention and with a driver 40 in seat 18. Driver 40 may be restrained by a three-point seat belt system 44 of the type well-known in the automotive safety field. Airbag 22 is fully inflated, as it would be approximate 40 milliseconds (ms) after the airbag is triggered (t=40 ms) by a crash sensing system (not shown).

For purposes of comparison, FIG. 6 depicts a prior art airbag 122 in a fully inflated condition also at t=40 ms. Prior art airbag 122 is thicker towards the lower, chest contact portion and thinner and sloping at the upper, head contact portion.

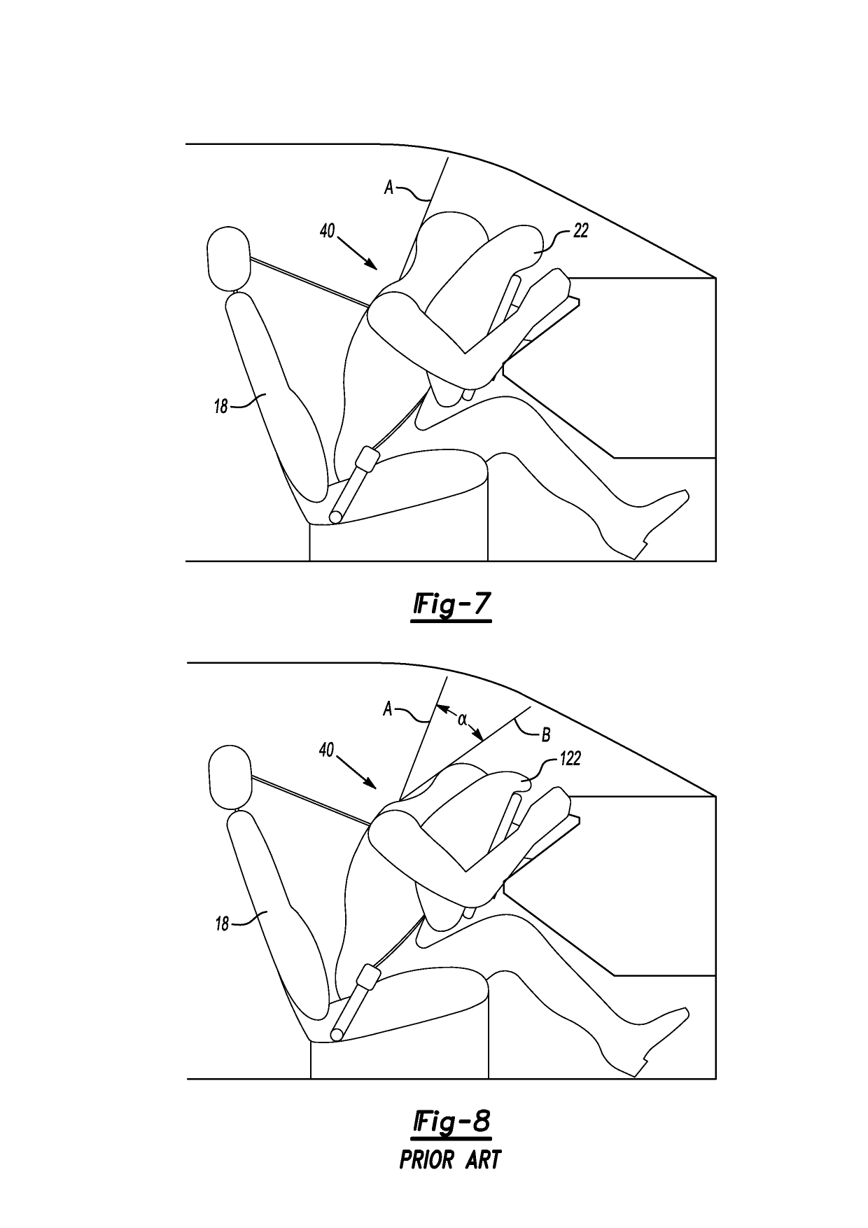

FIGS. 7 and 8 provide a comparison of driver/airbag interaction when using an airbag 22 according to an embodiment of the present invention and a prior art airbag 122 at approximately t=100 ms after the initiation of the frontal crash sequence and resulting activation of the airbag. Driver 40 is at or near its forward most position, i.e., it is pressed into maximum engagement or contact with airbag 22.

It should be noted that the driver's neck is in a relatively neutral position, i.e., it is not flexed forward, as a result of the greater thickness T_{U} of the airbag at head contact portion 30 limiting the forward movement of the head. In FIG. 7, a reference line A drawn from the base of the neck and tangent to the rear of the head indicates the amount of forward neck flexion. In FIG. 8, a similar reference line B indicates the amount of forward neck flexion with a prior art airbag 122. Reference line A is carried over to FIG. 8 for comparison purposes, and it is apparent that when using the prior art airbag 122 the head is well forward of the reference line A. The angle α indicates the reduction in the amount of neck flexion provided the airbag 22. It should also be noted that in FIG. 7 there is still significant clearance between driver's head and steering wheel upper rim 12b. This compares favorably with the prior art airbag configuration, where the head may come into contact with rim 12b.

The disclosed inflated shape of airbag 22 is thus shown to provide safety benefits as compared with prior art airbag designs by limiting the forward flexion of the driver's neck, and thereby reducing the bending moment applied to the neck. The reduced thickness T_{L} of the airbag at chest contact portion 32 also achieves a reduce compression loading on the driver's chest while still providing desired levels of cushioning and protection from injury. The disclosed driver-side airbag 22 also provides a surface in the head contact portion that is flatter than the prior art airbag 122, and so offers a more distributed force applied to the driver's face.

The upper tether 24 controls the shape and thickness of the upper portion (head contact portion) of the airbag which has a beneficial effect of reducing the driver's head acceleration and neck injury. The bottom tether 26 reduces the force applied to the driver's chest due to airbag contact. Therefore, a driver airbag of the disclosed shape can provide more balanced occupant protection in a frontal crash event.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

1. An airbag assembly for a motor vehicle comprising:
a steering wheel having an upper rim and a lower rim;
an airbag housing mounted to the steering wheel;
an airbag attached to the housing and having a deployed condition wherein a head contact portion of the airbag is adjacent to the upper rim of the steering wheel and a chest contact portion of the airbag is adjacent to the lower rim, the head contact portion having a thickness greater than a thickness of the chest contact portion;
an upper tether extending between the housing and a first location on the airbag adjacent a dividing line between the head contact portion and the chest contact portion; and
a lower tether extending between the housing and a second location on the chest contact portion.

2. The assembly of claim 1 wherein the airbag comprises:
a driver-facing panel;
a rim-facing panel; and
a wedge-shaped panel between and connecting the driver-facing panel and the rim-facing panel, the wedge-shaped panel being wider adjacent to an uppermost extent of the airbag to achieve the greater thickness of the head contact portion.

3. The assembly of claim 1 wherein the head contact portion has a maximum thickness at a level even with or above the upper rim.

4. The assembly of claim 1 wherein the upper and lower tethers are in the form of a strap.

5. The assembly of claim 4 wherein the tethers are approximately 3 inches wide.

6. The assembly of claim 1 wherein the head contact portion has a surface approximately parallel with a plane of the steering wheel.

7. An airbag assembly for a motor vehicle comprising:
a steering wheel comprising a center section, an upper rim, and a lower rim;
an airbag housing mounted to the steering wheel center section;
an airbag contained in the housing when in a deflated condition housing and inflatable to a deployed condition, the airbag in the deployed condition comprising a chest contact portion adjacent to the lower rim and a head contact portion adjacent to the upper rim, the head contact portion being of a first thickness greater than a second thickness of the chest contact portion;
an upper tether extending between the housing and a first location on the airbag adjacent a dividing line between the head contact portion and the chest contact portion; and
a lower tether extending between the housing and a second location on the chest contact portion.

8. The assembly of claim 7 wherein the airbag comprises:
a driver-facing panel;
a rim-facing panel; and
a wedge-shaped panel between and connecting the driver-facing panel and the rim-facing panel, the wedge-shaped panel being wider adjacent to an uppermost extent of the airbag to achieve the greater thickness of the head contact portion.

9. The assembly of claim 7 wherein the head contact portion has a maximum thickness at a level even with or above the upper rim.

10. The assembly of claim 7 wherein the upper and lower tethers are in the form of a strap.

11. The assembly of claim 10 wherein the tethers are approximately 3 inches wide.

12. The assembly of claim 7 wherein the head contact portion has a surface approximately parallel with a plane of the steering wheel.

13. An airbag assembly for a motor vehicle comprising:
a steering wheel comprising a hub, an upper rim, and a lower rim;
an airbag housing mounted to the hub; and
an airbag stored in the housing when in a deflated condition and comprising:
a rim-facing panel;
a driver-facing panel;
an upper tether extending between the housing and a first location on the driver-facing panel opposite from the hub; and
a lower tether extending between the housing and a second location on the driver-facing panel below the first location, the tethers being located to shape the airbag in an inflated condition to have a head contact portion adjacent to the upper rim and a chest contact portion adjacent to the lower rim, the head contact portion being of a first thickness greater than a second thickness of the chest contact portion.

14. The assembly of claim 13 wherein the airbag further comprises a wedge-shaped panel between and connecting the driver-facing panel and the rim-facing panel, the wedge-shaped panel being wider adjacent to an uppermost extent of the airbag.

15. The assembly of claim 13 wherein the head contact portion has a maximum thickness at a level even with or above the upper rim.

16. The assembly of claim 13 wherein the upper and lower tethers are in the form of a strap.

17. The assembly of claim 16 wherein the tethers are approximately 3 inches wide.

18. The assembly of claim 13 wherein the head contact portion has a surface approximately parallel with a plane of the steering wheel.
